(19) United States
(12) Patent Application Publication
(10) Pub. No.: US 2004/0056071 A1
(43) Pub. Date: Mar. 25, 2004

(54) Adhesive laminated braze sheet

(75) Inventor: Matthew J. Pohlman, Huntington Beach, CA (US)

Correspondence Address: Honeywell International, Inc., Law Dept. AB2, P.O. Box 2245, Morristown, NJ, 07962-9806, US

(73) Assignee: Honeywell International, Inc., Morristown, NJ

(21) Appl. No.: 10/255,498

(22) Filed: Sep. 25, 2002

(51) Int. Cl. B23K 31/02

(52) U.S. Cl. 228/175; 228/245

(57) ABSTRACT

Braze filler in the form of coiled melt spun foil is adhesively bonded to coiled parent sheet metal forming a coiled laminate which can be cut to desired shapes, and brazed as an assembly comprised of laminate and non-laminate parts. Because the parent metal and melt spun foil are cut at the same time, only one piece of material must be handled. The laminate may comprise melt spun foil on one or both sides of the parent metal, may be bonded to the parent metal by means of spraying, rolling, dripping, or brushing, and may be applied to either parent metal or melt spun foil, or both. Application of the adhesive may also be in a pattern rather than covering the entire surface of parent metal.

### BACKGROUND OF THE INVENTION

The present invention generally relates to methods for fabricating adhesive laminated braze sheets and, more specifically, to methods for bonding a braze filler in the form of melt spun foil to parent sheet metal, cutting the laminate to desired shapes, and then brazing an assembly comprised of laminate and non-laminate parts.

Sheet metal structures are used in a variety of industrial applications, under a diverse set of operating conditions. Examples of such structures include heat exchangers, honeycomb panels (such as those used for exterior skins of space vehicles), and combustion chambers. In many cases, the method used to fasten the individual structural elements together involves the use of a brazing process in a brazing furnace to integrally join the components together.

Brazing is a process for joining metal parts, often of dissimilar composition, to each other. Typically, a filler metal, which is generally a non-ferrous metal or alloy whose melting point is lower than that of the parent metal or alloy to be joined, is interposed between the parts to form an assembly. The assembly is then heated to a temperature sufficient to melt the filler metal. Upon cooling, a strong joint is formed.

Joints to be brazed are usually designed to require a thin film of filler metal, which is drawn into the joint by capillary action when the brazing material becomes molten. Conventionally, in order to perform the brazing process in a brazing furnace, it is necessary to provisionally assemble the various structural components together with the desired amount of brazing filler material. Conventional brazing filler materials exist in a wide variety of forms, which are characteristic of metallic material, namely: powders, pastes formed from powders, foils (such as melt spun foil available commercially as Metglas®), strips and rods.

Many methods for applying brazing material to the parent metal are recognized in the art. Those include: application of powdered brazing material to the parent metal by means of a liquid binder; application of braze filler metal pastes to the parent metal; securing, such as by means of spot welding or mechanical attachments, brazing material foil or sheets to the parent metal; thermally spraying molten brazing material to the parent metal; bonding by means of adhesives; and pressure roll bonding. The pressure roll bonding process, however, is generally limited to braze alloys such as aluminum, copper, silver, and gold, because they are soft and readily clad by pressure roll bonding.

Adhesives and adhesively backed braze foil have been successfully utilized as a means to attach braze foil to parent metals. See, for example, U.S. Pat. No. 3,710,473 to McElwain et al., which addresses brazing foil in the form of a tape having an adhesive backing. Similarly, U.S. Pat. No. 6,387,527 to Hasz et al., teaches use of a braze foil that can be tack-welded or adhesively attached. To use the adhesive backed material, both the parent metal sheet to be brazed and the brazing foil need to be cut to the desired size and cleaned if necessary. A protective covering is then peeled off the adhesive exposing the adhesive. The brazing foil is then applied to the surfaces of the metal to be brazed. Handling of two or more pieces of material (parent metal and braze foil) is required. Additionally, adhesive backed material is difficult to use because it is non-forgiving; if it is applied crooked, it is stuck and difficult to rearrange.

Nickel based braze filler in the form of melt-spun foil is used to assemble sheet metal structures such as heat exchangers made from material such as Inconel 625. Because nickel based melt-spun filler alloys are brittle and will crack due to deformation, they cannot be clad by conventional roll bonding. Accordingly, the braze alloy foil must be handled separately from the parent material being brazed and commonly requires separate cutting, cleaning and packaging. Additionally, positioning the braze foil on the parent metal for brazing usually requires spot welding, which is time consuming and can damage the parent metal.

New methods for efficiently applying nickel based melt spun foil braze filler to sheet metal structures would therefore be welcomed in the art. It would also be desirable if such methods were compatible with conventional assembly techniques for brazed sheet metal structures, would be usable for braze filler metals other than those which are nickel based, and would have no detrimental effect whatsoever on the strength or other physical characteristics of the finished structures.

As can be seen, there is a need for improved apparatus and methods for bonding a nickel based braze filler in the form of melt-spun braze foil to parent sheet metal and then brazing the laminate to desired shapes, thus vastly reducing the number of manufacturing steps.

### SUMMARY OF THE INVENTION

In one aspect of the present invention, a method for laminating melt spun foil braze filler to parent metal for fabricating brazed assemblies is disclosed. It comprises the steps of: uncoiling a parent metal starting coil; uncoiling at least one melt spun foil starting coil; feeding, to an adhesive application system, parent metal obtained by uncoiling the parent metal starting coil; feeding, to the adhesive application system, melt spun foil obtained by uncoiling the melt spun foil starting coil; applying adhesive with the adhesive application system to a planar surface of the parent metal; compressing and bonding with pressure rollers the melt spun foil to the parent metal thereby forming laminated braze clad sheet comprised of the parent metal bonded to at least one melt spun foil; coiling the laminated braze clad sheet onto a take up coil; forming laminated braze clad components comprised of elements from the laminated braze clad sheet take up coil; and, forming brazed assemblies comprised of the laminated braze clad components and components of the parent metal.

In another aspect of the present invention, there is disclosed a method for laminating melt spun foil braze filler to parent metal for fabricating brazed assembles, comprising the steps of: positioning parent metal sheets adjacent melt spun foil sheets; applying adhesive to the parent metal sheets; positioning the parent metal sheets, including adhesive, over the melt spun foil sheets; bonding the melt spun foil sheets to the parent metal sheets and adhesive; forming laminated braze clad sheets comprising the parent metal sheets, the adhesive, and at least one melt spun foil sheet; forming laminated braze clad components comprised of elements from the laminated braze clad sheets; and, forming brazed assemblies comprised of the laminated braze clad components and components from the parent metal sheets.

In yet another aspect of the present invention, a method for fabricating brazed assemblies using melt spun foil laminated to parent metal, comprises the steps of applying adhesive to parent metal obtained from a parent metal coil; compressing melt spun foil from at least one melt spun foil coil to parent metal; bonding melt spun foil to parent metal to produce laminated braze clad sheet; storing laminated braze clad sheet in a take up coil; cutting laminated braze clad sheet components from the laminated braze clad sheet take up coil; and fabricating brazed assemblies from laminated braze clad components and optional non-clad components.

In yet one final aspect of the present invention, a method for fabricating brazed assemblies using melt spun foil laminated to parent metal, comprises the steps of applying adhesive to parent metal; compressing melt spun foil to parent metal; bonding melt spun foil to parent metal to produce laminated braze clad sheet; cutting laminated braze clad sheet components from the laminated braze clad sheet; and fabricating brazed assemblies comprised of laminated braze clad components and optional non-clad components.

These and other features, aspects and advantages of the present invention will become better understood with reference to the following drawings, description and claims.

### BRIEF DESCRIPTION OF THE DRAWINGS

FIG. 1 is a schematic representation of a bonding and laminating apparatus according to one embodiment of the present invention;

FIG. 1A is a schematic representation of a bonding and laminating apparatus according to another embodiment of the present invention;

FIG. 1B is a partial plan view of a bonding and laminating apparatus taken along section A-A of FIG. 1A.

FIG. 2 is a perspective view showing components cut from a laminated braze clad sheet made according to one embodiment of the present invention;

FIG. 3 is a cross sectional view of a brazed sandwich stack assembly utilizing laminated braze clad sheet made according to one embodiment of the present invention;

FIG. 4 is a cross sectional view of another brazed sandwich stack assembly utilizing laminated braze clad sheet made for evaluation test purposes;

FIG. 5A is a plan view of a laminated braze clad sheet showing an adhesive pattern embodiment;

FIG. 5B is a plan view of a laminated braze clad sheet showing another adhesive pattern embodiment.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention generally provides methods for laminating, by means of a bonding adhesive, a nickel based melt-spun braze foil, as well as other types of braze foil, onto parent metal as a continuous coil. The laminated coil (comprised of parent metal and melt spun foil) can then be slit or cut to size as necessary, assembled, and brazed in a vacuum. Because the parent metal and melt spun foil are cut at the same time, only one piece of material must be handled. This is unlike prior art for nickel based melt-spun foil which requires that the braze alloy foil be handled separately from the metal being brazed, including separate cutting, cleaning, and packaging. Moreover, prior art generally requires positioning the braze foil on the parent metal and then spot welding or bonding it in place, a process which is not only time consuming but also can damage the parent metal.

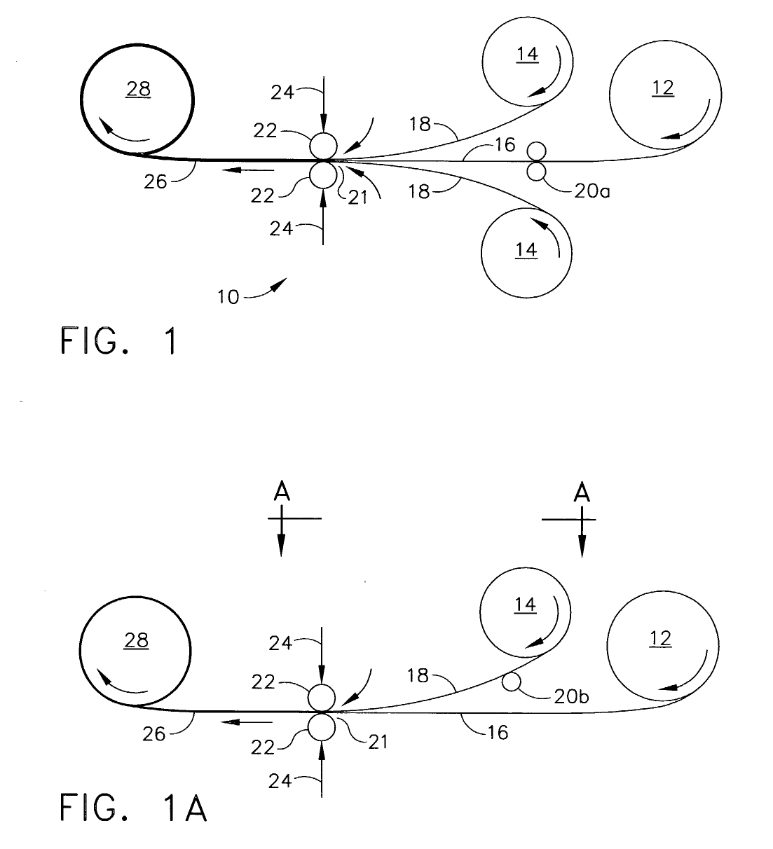

Referring to the accompanying drawings (in which like reference numerals indicate like parts throughout several views), and in particular to FIG. 1, there is shown a schematic representation of an adhesive laminating braze apparatus 10 according to one embodiment of the present invention. This embodiment may comprise the process of laminating both parent metal and melt spun foil in a coil stage. As shown, a parent metal starting coil 12 may be positioned between two melt spun foil coils 14 so that roller rotation in the direction of the arrows may release melt spun foil 18 on each side of parent metal 16. An adhesive application system 20a, such as an adhesive spray, may be located downstream of parent metal starting coil 12, to apply adhesive to both sides of parent metal 16 as it is unrolled in the direction of pressure rollers 22.

Pressure rollers 22, downstream of merging point 21, may provide pressure 24 as required to achieve an effective adhesive lamination of parent metal 16 with melt spun foils 18 on both surfaces. The pressure to be provided may be varied to correspond to the requirements of the specific adhesive being applied. By way of example, a minimal pressure in the range of 0.1 to 1.0 psi, (such as would be achieved by hand rolling) may be needed for commercially available 3M Super 77 adhesive spray. Following the adhesive lamination process, laminated braze clad sheet 26 may be wound on laminated braze clad take up coil 28, and stored for subsequent braze process assembly operations, described below.

As can be appreciated, other embodiments of the adhesive laminating process are possible. By way of examples:

1. The lamination process does not need to be accomplished with the laminating materials in a coil stage. Other laminating processes, such as laminating sheet stock, may be effectively used.

2. The laminated braze clad sheet 26 may comprise only one layer of melt spun foil 18, instead of two as shown in FIG. 1A.

3. Adhesive may be applied by spraying, rolling, dripping, or brushing, and may be applied to the parent metal 16, as shown in FIG. 1, or to the melt spun foil 18, as shown in FIG. 1A. In the latter case, the alternate adhesive application system 20b may apply adhesive to the melt spun foil upstream of merging point 21. A further alternate embodiment may involve application of adhesive to both parent metal 16 (as in FIG. 1) and melt spun foil 18 (as in FIG. 1A).

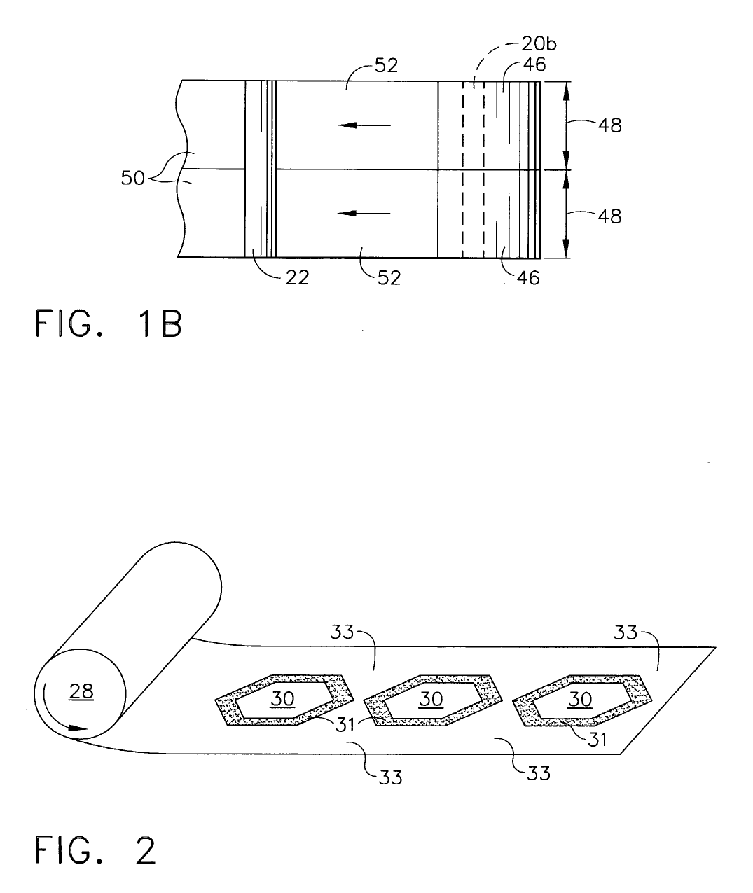

4. Application of the adhesive may also be in a pattern rather than covering the entire surface of parent metal 16 and/or melt spun foil 18, thus the amount of the adhesive required may be reduced. FIG. 2 illustrates a laminated braze clad take up roll 28 from which laminated braze clad components 30 may be cut. By way of example, adhesive may be applied only within adhesive pattern 31 which may extend beyond the periphery of laminated braze clad components 30. Application of adhesive pattern 31 may leave unbonded regions 33 between and to the sides of adhesive pattern 31, a condition which may be acceptable providing laminated braze clad components 30 cut from laminated braze clad take up coil 28 are smaller than adhesive pattern 31 to ensure that the melt spun foil 18 remains bonded to parent metal 16.

5. Commercially available Metglas® melt spun foil is generally available only in 5.5 inch widths. If the parent metal to be laminated is wider than 5.5 inches, multiple strips (as illustrated below) of melt spun foil 18 may be laminated adjacent to each other to cover the entire width of the parent metal 16. This method is illustrated in FIG. 1B, which is a partial plan view of a bonding and laminating apparatus taken along section A-A of FIG. 1A. A plurality (two are shown) of Metglas® melt spun foil coils 46, having a coil width 48 of 5.5 inches each, are positioned immediately adjacent each other and are bonded to parent metal 16 (not shown in FIG. 1B) using alternate adhesive application system 20b. After traversing through pressure rollers 22, Metglas® melt spun foil clad sheet 50, comprising multiple strips of Metglas® melt spun foil 52, is produced. The adhesive selected for the laminating process may be of the type that burns off readily in the braze furnace as the parts are being heated, leaving no residue that would hinder the brazing alloy flow. In other words, the adhesive may have a low ash content so that when it volatizes it may leave the assembly as a gas and does not leave significant residual material in the brazed joint. Insofar as strength is concerned, the adhesive needs to hold well enough to permit handling of laminated braze clad sheet 26, and it does not need great strength. An ideal adhesive may be strong enough to allow bending, shearing, and cutting of laminated braze clad sheet 26 without melt spun foil 18 falling off. Minor peeling may be acceptable. 3M Super 77™ adhesive spray may be an example of such an adhesive.

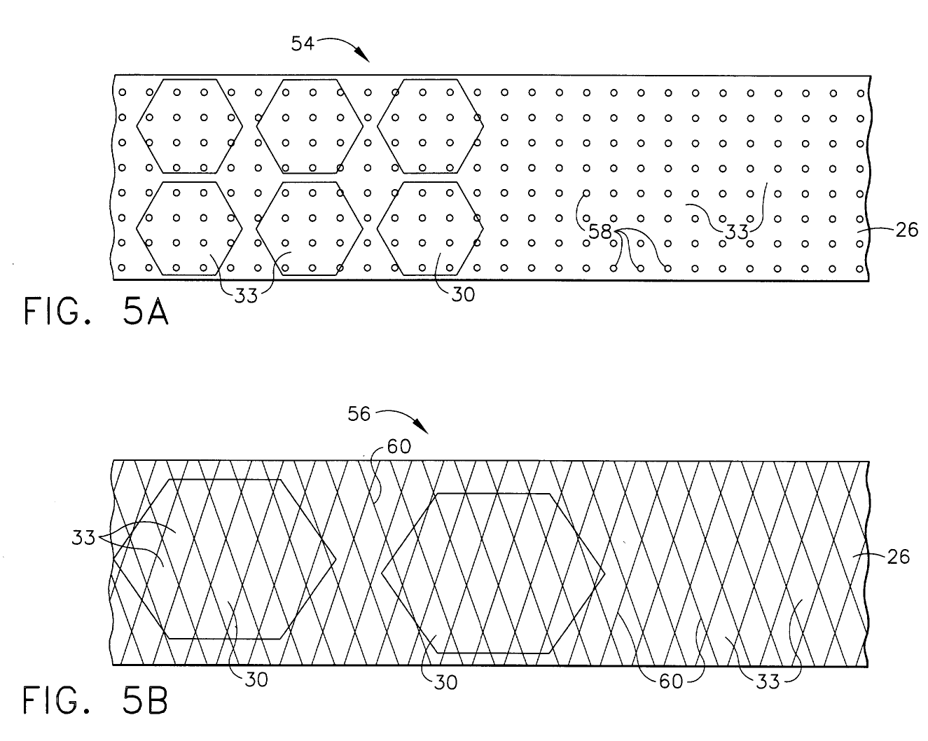

6. Application of adhesive may also be in a pattern that may reduce the amount of adhesive in brazed joints 35. Such a pattern may be a dot pattern 54 or screen pattern 56 as shown correspondingly in FIGS. 5A and 5B. The dot pattern 54 in FIG. 5A is comprised of multiple adhesive dots 58, which may be in a symmetrical pattern placed on the laminated braze clad sheet 26 during the bonding process described above. (The adhesive dots 58 are shown for illustration purposes only as they would not be visible when viewing the laminated braze clad sheet 26 outer surface.) Such a pattern may have unbonded regions 33 where laminated braze clad components 30 are not bonded to the parent metal 16. Similarly, the screen pattern 56 in FIG. 5B is comprised of multiple adhesive lines 60, which may be in a symmetrical pattern placed on the laminated braze clad sheet 26 during the bonding process described above. (The adhesive lines 60 are shown for illustration purposes only as they would not be visible when viewing the laminated braze clad sheet 26 outer surface.) Such a pattern may also have unbonded regions 33 where laminated braze clad components 30 are not bonded to the parent metal 16. In both of the above cases (dot pattern 54 and screen pattern 56), laminated braze clad sheet components 30 would have areas where the melt spun foil 18 may not be bonded to the parent metal 16, but the melt spun foil 18 would still be adhered to the parent metal 16 sufficiently to withstand subsequent component cutting and handling operations. The benefit of having large unbonded areas on a component may be the reduced potential for the adhesive to leave residual contamination in the final brazed joint 35 due to less adhesive being present.

Again referring to FIG. 2, there is shown a perspective view of typical components that may be cut from laminated sheets made according to one embodiment of the present invention. Laminated braze clad take up coil 28, comprising parent metal 16 and melt spun foil 18, may be used as the source for fabrication of laminated braze clad components 30. With the inventive process, laminated braze clad components 30 may be cut, sheared, bent, slit, or cut to size resulting in a braze alloy coated structure in one step. Previously, braze alloy foil had to be handled separately from the metal being brazed, including separate cutting, cleaning, and packaging. Moreover, it was generally required to position braze foil on the parent metal and then spot weld or bond it in place, a time consuming process which also can damage the parent metal. Thus, the inventive process has effectively eliminated the need to separately handle parent metal and melt spun foil.

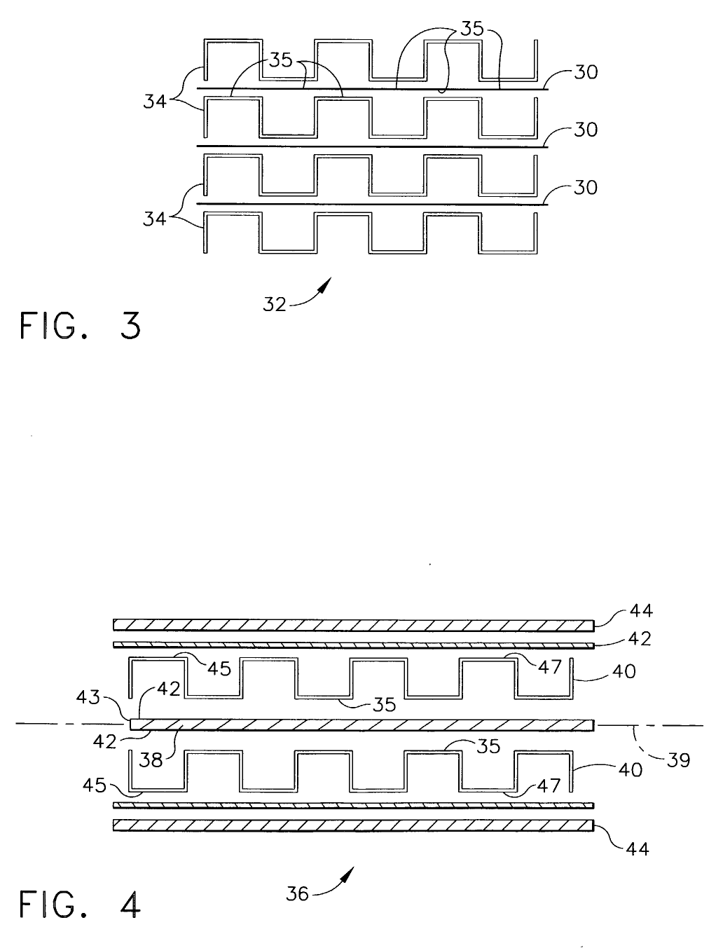

FIG. 3 shows a cross sectional view of a brazed sandwich stack assembly 32 comprising non-clad components 34, that is, parent metal components not bonded or mated to a brazing metal, as well as laminated braze sheet made according to one embodiment of the present invention. A plurality of non-clad components 34, such as pre-formed heat exchanger fins which may be made of Type 444 stainless steel, may be assembled in a vertical planar relationship with each other, each being interspersed by laminated braze clad components 30, such as those shown in FIG. 2. The assembly may thereafter be heated in a brazing furnace to a suitable temperature (generally in the range of 1800° F. to 2100° F.) that melts the melt spun foil 18 but not the parent metal 16, resulting in a brazed sandwich stack assembly 32 held together by braze joints 35. The adhesive (applied by adhesive application system 20a or 20b) may volatize during the heating process, leaving minimal residue remaining in the brazed joints 35 and on the surfaces of the laminated braze clad components 30.

FIG. 4 shows a cross sectional view of a sandwich stack assembly test article 36 made to evaluate the characteristics of inventive adhesive laminated braze sheets. A laminated sheet 38 located at the horizontal centerline 39 of said sandwich stack assembly test article 36, is comprised of two melt spun foil 42 sheets of 0.0015 inch thick Metglas®, composition AMS 4777, laminated one to each side of a 0.006 inch thick metallic sheet 43 of Inconel 625, using 3M Super 77™ adhesive spray. Fins 40, such as used for conventional heat exchangers, made of Type 444 stainless steel, are positioned in parallel relationship, one to each side of laminated sheet 38. The outer surfaces 45 of both fins 40 have conventional non-laminated braze joints 47, comprised of melt spun foil 42 sheets of 0.0015 inch thick Metglas® sandwiched between outer sheets 44 of 0.006 inch thick Inconel 625. Melt spun foil 42 sheets were not laminated (bonded) to outer sheets 44 in order to compare brazing qualities with laminated sheet 38.

Three samples of sandwich stack assembly test article 36 were made and brazed in a vacuum at conventional temperatures. For comparison purposes, sample sizes and fin 40 coarseness (the number of fins per inch, which, for the test articles, were 11, 12 and 26) were varied. Thereafter the samples were cross sectioned to examine laminated sheet 38 braze joints 35 and non-laminated braze joints 47. Sections were made through the centers of each sample, including a full width cross-section of one. All areas of all samples had good braze joints 35 and 47 with no evidence of contamination from the adhesive or of unacceptable separation of the braze joints 35 and 47 from the fins 40. Braze joints 35 at laminated sheet 38 looked identical to non-laminated braze joints 47, where the melt spun foil 42 was placed on fins 40 with no adhesive. There was no difference in brazed joint quality between large and small samples or among variations of the fin 40 coarseness, thus proving validity of the inventive concept.

In view of the above, it can be seen that the present invention provides a method for fabricating brazed sandwich stack assemblies 32 using melt spun foil 18 laminated to parent metal 16. The method comprises the steps of applying adhesive to parent metal 16 or melt spun foil 18, compressing melt spun foil 18 to the parent metal 16, bonding the melt spun foil 18 to parent metal 16 to produce laminated braze clad sheet 26 from which laminated braze clad components 30 may be cut and used for fabricating assemblies which may include non-clad components 34.

It should be understood, of course, that the foregoing relates to preferred embodiments of the invention and that modifications may be made without departing from the spirit and scope of the invention as set forth in the following claims.

We claim:

1. A method for laminating melt spun foil braze filler to parent metal for fabricating brazed assemblies, comprising the steps of
uncoiling a parent metal starting coil;
uncoiling at least one melt spun foil starting coil;
feeding, to an adhesive application system, parent metal obtained by uncoiling said parent metal starting coil;
feeding, to said adhesive application system, melt spun foil obtained by uncoiling said melt spun foil starting coil;
applying adhesive with said adhesive application system to a planar surface of said parent metal;
compressing and bonding with pressure rollers said melt spun foil to said parent metal thereby forming laminated braze clad sheet comprised of said parent metal bonded to at least one melt spun foil;
coiling said laminated braze clad sheet onto a take up coil;
forming laminated braze clad components comprised of elements from said laminated braze clad sheet take up coil;
forming brazed assemblies comprised of said laminated braze clad components and components of said parent metal.

2. The method of claim 1, further comprising the step of applying adhesive with said adhesive application system to a planar surface of the melt spun foil.

3. The method of claim 1, further comprising the step of bonding said melt spun foil to both sides of said parent metal.

4. The method of claim 1, further comprising the step of applying said adhesive by spraying with said adhesive application system.

5. The method of claim 1, further comprising the step of applying said adhesive by rolling with said adhesive application system.

6. The method of claim 1, further comprising the step of applying said adhesive, with said adhesive application system, to both planar surfaces of said parent metal.

7. The method of claim 1, further comprising the step of applying said adhesive, with said adhesive application system, to an entire planar surface of said parent metal.

8. The method of claim 1, further comprising the step of applying said adhesive, with said adhesive application system, in a pattern to a planar surface of said parent metal.

9. The method of claim 1, further comprising the step of forming said melt spun foil from Metgals®, said parent metal, and said adhesive.

10. The method of claim 1, further comprising the step of forming said melt spun foil from a nickel based braze filler metal, said parent metal, and said adhesive.

11. A method for laminating melt spun foil braze filler to parent metal for fabricating brazed assembles, comprising the steps of
positioning parent metal sheets adjacent melt spun foil sheets;
applying adhesive to said parent metal sheets;
positioning said parent metal sheets, including said adhesive, over said melt spun foil sheets;
bonding said melt spun foil sheets to said parent metal sheets and adhesive;
forming laminated braze clad sheets comprising said parent metal sheets, said adhesive, and at least one of said melt spun foil sheets;
forming laminated braze clad components comprised of elements from said laminated braze clad sheets;
forming brazed assemblies comprised of said laminated braze clad components and components of said parent metal sheets.

12. The method of claim 11, further comprising the step of applying said adhesive to said melt spun foil.

13. The method of claim 11, further comprising the step of bonding said melt spun foil to both sides of said parent metal.

14. The method of claim 11, further comprising the step of applying said adhesive by spraying.

15. The method of claim 11, further comprising the step of applying said adhesive by rolling.

16. The method of claim 11, further comprising the step of applying said adhesive to one side of said parent metal.

17. The method of claim 11, further comprising the step of applying said adhesive to both sides of said parent metal.

18. The method of claim 11, further comprising the step of applying said adhesive to an entire surface of said parent metal.

19. The method of claim 11, further comprising the step of applying said adhesive to said parent metal in a pattern.

20. The method of claim 11, further comprising the step of forming melt spun foil from a nickel based braze filler metal, said parent metal, and said adhesive.

21. A method for fabricating brazed assemblies using melt spun foil laminated to parent metal, comprising the steps of
applying adhesive to parent metal obtained from a parent metal coil;
compressing melt spun foil from at least one melt spun foil coil to said parent metal;
bonding said melt spun foil to said parent metal to produce laminated braze clad sheet;
storing said laminated braze clad sheet in a take up coil;
cutting laminated braze clad sheet components from said laminated braze clad sheet take up coil;
fabricating brazed assemblies comprising laminated braze clad components and optional non-clad components of parent metal without melt spun foil.

22. The method of claim 21, further comprising the step of applying adhesive to a planar surface of said melt spun foil.

23. The method of claim 21, further comprising the step of bonding said melt spun foil to both sides of said parent metal.

24. The method of claim 21, further comprising the step of applying adhesive by spraying.

25. The method of claim 21, further comprising the step of applying adhesive by rolling.

26. The method of claim 21, further comprising the step of applying adhesive to an entire planar surface of said parent metal.

27. The method of claim 21, further comprising the step of applying adhesive in a pattern to a planar surface of said parent metal.

28. A method for fabricating brazed assemblies using melt spun foil laminated to parent metal, comprising the steps of
applying adhesive to parent metal;
compressing melt spun foil to parent metal;
bonding said melt spun foil to said parent metal to produce laminated braze clad sheet;
cutting laminated braze clad sheet components from said laminated braze clad sheet;
fabricating brazed assemblies comprising laminated braze clad components and optional non-clad components of parent metal without melt spun foil.

29. The method of claim 28, further comprising the step of applying adhesive to said melt spun foil.

30. The method of claim 28, further comprising the step of bonding said melt spun foil to both sides of said parent metal.

31. The method of claim 28, further comprising the step of applying adhesive by spraying.

32. The method of claim 28, further comprising the step of applying adhesive by rolling.
